(19) United States
(12) Patent Application Publication
(10) Pub. No.: US 2017/0298181 A1
(43) Pub. Date: Oct. 19, 2017

(54) COPOLYAMIDES WITH ALTERNATING REPEAT UNITS

(71) Applicant: DSM IP ASSETS B.V, Heerlen (NL)

(72) Inventors: Rudy RULKENS, Echt (NL); Martin WOLFFS, Echt (NL)

(21) Appl. No.: 15/515,624

(22) PCT Filed: Oct. 1, 2015
(86) PCT No.: PCT/EP2015/072686

§ 371 Date: Mar. 30, 2017

(30) Foreign Application Priority Data
Oct. 3, 2014 (EP) 14187580.7

(51) Int. Cl. C08G 69/30; C08G 69/26; C08L 77/06

(52) U.S. Cl. CPC C08G 69/30; C08L 77/06; C08G 69/26; C08L 2205/025

(57) ABSTRACT

The invention relates to a process for the preparation of a PA XY/XZ polyamide, more particular a copolyamide having alternating XY units and XZ units and a process for the manufacture thereof. Further, the present invention relates to compositions and articles comprising said copolyamide. Furthermore, the present invention relates to diamines and salts which are intermediary products of the process for the manufacture of said copolyamide.

The invention relates to a process for the preparation of a PA XY/XZ polyamide, more particular a copolyamide having alternating XY units and XZ units and a process for the manufacture thereof. Further, the present invention relates to compositions and articles comprising said copolyamide. Furthermore, the present invention relates to diamines and salts which are intermediary products of the process for the manufacture of said copolyamide.

Semi-crystalline polyamides are generally prepared by liquid phase polymerization, optionally in the presence of water, such as melt polymerization or solution polymerization. Amorphous polyamides are generally made by melt-polymerization. After the liquid phase polymerization, the resulting polymer, or prepolymer thereof, is either isolated from the solution or the melt is cooled to solidify. Such liquid phase polymerization may optionally be followed by a solid state post-condensation step, to obtain a polyamide polymer with a higher molecular weight. Furthermore, in the literature also solid state polymerization processes involving direct solid state polymerization of nylon salts are described. Herein the polymerization is carried out such that during the whole polymerization process from salt to polymer, the starting salt, the intermediate products and final product remain in the solid state, or essentially so and thus never fully liquefy.

Semi-crystalline semi-aromatic polyamide copolymers, abbreviated herein as Co-PA, with melting temperature (Tm), for example with Tm above 280° C. (which is in the context of the present invention considered as a high value), more particular above 300° C., are of interest for many applications because of their high melting temperature properties. Such polyamides are generally copolyamides obtained from diamine and dicarboxylic acid. Herein the dicarboxylic acid can be an aromatic dicarboxylic acid, such as terephthalic acid, which is combined with a mixture of different aliphatic diamines. More commonly, the dicarboxylic acid comprises a combination of different dicarboxylic acids, for example terephthalic acid and isophthalic acid, or terephthalic acid and adipic acid, or terephthalic acid, adipic acid and isophthalic acid. The diamine may also comprise a mixture of different diamines. For such polyamides multistep processes are applied, such as solution polymerization, melt polymerization, or solution polymerization followed by melt polymerization, each optionally combined with solid state post condensation. Aromatic dicarboxylic acids, such as terephthalic acid and isophthalic acid, are known to be significantly less reactive than aliphatic dicarboxylic acids, such as adipic acid. Because of the higher melting points of the semi-crystalline semi-aromatic polyamides based on terephthalic acid, and lower reactivity of the aromatic dicarboxylic acids, higher reaction temperatures may be needed which can result in undesired side reactions. For example one type of side reactions can be intermolecular condensation reaction of diamines results into components with higher functionality which leads to branching of the polyamides, and can result in gelation. One way to prevent gelation by said type of side reaction is to add mono-functional carboxylic acids or amines, which act as chain stoppers. On the other hand short diamines like 1,4-diaminobutane and 1,5-diaminopentane undergo cyclization by internal amine condensation leading to mono-functional amines and therefore restricting the build-up of higher molar mass polyamide. The preparation of high melting semi-crystalline polyamides is therefore more complicated or problematic than for lower melting semi-aromatic or amorphous semi-aromatic polyamides. Furthermore, the longer reaction times result in reduced plant capacity utilization compared to aliphatic polyamides.

There are different types of copolyamides, as defined in the literature. Typical classes are block copolymers, statistically random copolymers and alternating copolymers. In the ideal situation these polymers have the following randomness factor R: R=0 for block copolymers, R=1 for statistically random copolymers, and R=2 for fully alternating copolymers.

In block copolymers, the polymer chain contains different blocks each composed of different monomers or monomer compositions. The different blocks are often incompatible with each other. Block copolymers generally display the properties that are characteristic to the separate polymeric blocks it is made up from. Some properties may as well be unpredictable depending on the polymers. For example these polymers will have multiple melting temperatures, each one corresponding to a separate block. In block copolymers or polyamide blends the stiffness of the material considerably decreases upon passing the melting point of the lowest melting polyamide block, effect which also occurs if the two blocks or two polyamides are misible in the melt. Particularly when the lowest melting material comprises a large part of the material, it impairs the use of the block copolyamide or blend for example in some plastic engineering applications.

Statistical copolymers are formed when the comonomers polymerize together at random. The distribution of the monomers obey known statistical laws. Besides starting from the separate monomers, statistical copolyamides can also be produced by transamidation of the homopolymers. If the monomers are mixed together at the same time, a statistical copolymer is produced. Statistical copolymers tend to have lower melting points than other types of copolymers, because their comonomers are blended together to form a copolymer. The blending thereof results in a loss of regularity in the polymer structure leading to a decrease in melting temperature leading to a loss in crystallinity and crystallization rate, due to less available segments that can crystallize having the consequence that moisture uptake is higher as expected based on the moisture uptake of homopolymers. Another effect of the lower regularity of statistical copolymers is that some regions will melt at lower temperatures than others, leading to a less defined, broader melting point for the overall polymer.

Copolymer with (perfectly) alternating repeat units are made up of different repeat (or repeating) units which are arranged alternately along the polymer chain. To achieve said perfect alternation of copolymer units, copolymer chains need to be composed of two different repeat units. When the copolymer is a polyamide, the copolymer can be composed of AA type monomers and BB type monomers, such as diamines and dicarboxylic acids, respectively or their derivatives. Another possibility can be a copolymer composed of AB type monomers: aminoacids or lactams. For perfect alternation of the copolymer repeat units AA and BB, the molar ratio of the two repeat units AA and BB relative to each other is 1:1. One way to represent a copolymer with alternating repeat units -AA-BB- is: AA-BB1-AA-BB2-AA-BB1-AA-BB2-AA-BB1, wherein AA is the diamine based building block and BB1 and BB2 are building blocks from two different dicarboxylic acids. The molar ratio of the monomers in the copolymer is AA/BB1/BB2 is 0.5/0.25/0.25.

The melting point of alternating copolymers is often around the average of the melting points of their respective homopolymers and they typically have an improved (i.e. higher) crystallinity and higher melting point compared to the corresponding statistic copolymer with the same monomer composition. Particularly, when the different comonomers are not isomorphous (Examples of isomorphous copolyamides can be PA 6T/66 and PA6CHDA/66 where CHDA is 1,4-trans cyclohexanedicarboxylic acid).

A considerable drawback in the processes for the manufacture of alternating copolymers is that usually in normal synthetic procedures transamidation reactions (transfer of an amide group from one compound to another) cannot be excluded and thus a random distribution of the monomers is favored. A further drawback is that typical processes that avoid transamidation use solvents and use activated monomers like for example nitrophenyl esters of dicarboxylic acids. Drawbacks can be:

expensive derivatization steps of the dicarboxylic acids which may also be complicated (recycling or discarding of an activation molecule and/or solvent involved);

constraints such as difficult control of heat emissions and/or low polycondensation temperature, in order to avoid amide exchange reactions;

additional reaction steps such as drying off or extraction out residual solvent; and/or

limited use of the reactor due to the limited polymer concentration for a maximum allowed viscosity in the process.

Accordingly, generally, a lengthy procedure is used to obtain alternating copolyamides and the yield may not always be satisfactory. So far, no method for suitably preparing copolyamides which repeat units are perfectly alternating and involving semi-aromatic polyamide blocks can be found in the literature. Similarly, no method for suitably preparing copolyamides which repeat units are perfectly alternating and involving aliphatic polyamide blocks comprising an aliphatic diamine longer than 6 carbons, or longer than 8 carbons, or longer than 9 carbons, or longer than 10 carbons, or longer than 12 carbons and/or an aliphatic dicarboxylic acid longer than 6 carbons, or longer than 8 carbons, or longer than 9 carbons, or longer than 10 carbons, or longer than 12 carbons can be found in the literature. Additionally, no literature reports the production of semi-aromatic alternating AABB type copolyamides.

Accordingly, there is a need to provide copolyamides with alternating units of each component of the copolyamide, and a process for the manufacture of said copolyamides. The present invention provides such a copolyamide and its process of manufacture which avoid the above mentioned drawbacks. The present invention provides a process for the manufacture of a PA XY/XZ copolyamide having alternating units of a first polyamide XY (PA XY) and a second polyamide XZ (PA XZ) comprising:

a) reacting diamine X and dicarboxylic acid Y, or derivatives thereof, thereby making a XYX diamine;
b) reacting the XYX diamine with a dicarboxylic acid Z, or derivative thereof, thereby making a salt XYX,Z thereof (wherein the salt comprises, or even consists of, a cation of the XYX diamine obtained in a) and a anion of the dicarboxylic acid Z);
c) solid state polymerizing the salt XYX,Z obtained in b) at a temperature of at least 5° C. below the melting point of the salt obtained after step b) as measured by DSC at a heating rate of 10° C./min according to standard ISO 11357-3 (2009),
wherein PA XY is a semi-crystalline semi-aromatic polyamide or an aliphatic polyamide obtained from a C2 to C36 dicarboxylic acid and a C2 to C36 diamine and PA XZ is a semi-crystalline semi-aromatic polyamide or an aliphatic polyamide obtained from a C2 to C36 dicarboxylic acid and a C2 to C36 diamine, and wherein Y and Z are different dicarboxylic acids, or derivatives thereof. In the context of the present invention, step c) is a solid state polymerization. The solid state polymerization can also be designated as ‘direct’ solid state polymerization. The term solid state polymerization can be understood herewith as direct solid state polymerization processes. In such a process, the salt used is generally a granular material, such a powder, and the aim is to obtain the resulting polymer as a granular material. The salt material used herein can be a salt powder or granular material obtained, for example, by spray drying, precipitation from solution, or a dry route process involving reaction of liquid diamine with solid dicarboxylic acid. The salt may have a particular shape of compacted powder particles. The solid state polymerization process can be any known solid state polymerization process, such as processes comprising solid state post condensation of polyamide prepolymer obtained by melt polymerization, and direct. Optionally the salt may be in a processed form obtained by melt or solid state processing.

In the context of the present invention the term “PA XY/XZ copolyamide having alternating units of a first polyamide XY and a second polyamide XZ” or “copolyamide having alternating XY units and XZ units” can also be designated as ‘PA XY/XZ alternating copolyamide’, ‘alternating copolyamide’, or ‘alternating copolymer’.

In the context of the present invention, by ‘dicarboxylic acids, or derivatives thereof’ (i.e. Y and/or Z) is to be understood dicarboxylic acids, or derivatives thereof such as esters of dicarboxylic acids (preferred are methyl or ethyl, ethylene, nitrophenyl or pentafluorophenyl carboxyloates), acid halides (preferred are acid chlorides), anhydrides, nitriles. Preferably, Z is an ester of dicarboxylic acid (preferred are methyl or ethyl, ethylene, nitrophenyl or pentafluorophenyl carboxyloates), acid halides (preferred are acid chlorides). Z can be also be a salt of dicarboxylic acids (preferred are ammonium salts).

In the context of the present invention, step a) is a step wherein the diamine X is contacted and reacted with the dicarboxylic acid or derivative thereof Y in a ratio X:Y of at least 2:1, preferably in the range from 2:1 to 100:1, more preferably in the range from 2.1:1 to 10:1, even more preferably from 2.5:1 to 10:1. In the context of the present invention, step b) can advantageously be carried out in solution, i.e. in a suitable solvent, such as an aqueous or organic solvent. In the context of the present invention, in step c) the polymerization of the salt obtained in step b) is carried out. Step a) can be carried out with the same diamine X as solvent or by adding an additional solvent. Advantageously, diamine X can be reused (recycled) in the process. Advantageously the XYX diamine is precipitating from the solvent. In another embodiment Y can be added gradually during the preparation of XYX. Optionally, XYX is purified by for example recrystallization. Step c) is carried out at a temperature of at least 5° C. below, preferably at least 10° C. below the melting point of the salt obtained after step b). Herein the melting point is measured by DSC at a heating rate of 10° C./min according to standard ISO 11357-3 (2009).

In the context of the present invention, the ranges (expressed as “in the range from . . . to . . . ”, or “from . . . to . . . ”) do include the lower and upper limit of the range.

In order to explain the strict alternation, or perfect alternation, which is to be understood in the context of the present invention, the following is herewith recited. In copolyamides in general, combinations of repeat units have the limitation that the sum of all probabilities is 1 (100%) and that the molar content of monomers of AA (designated in the context of the present invention as diamine X) and the molar content of monomers BB (designated in the context of the present invention as the dicarboxylic acids Y and Z, therefore BB is sum of Y and Z) is equal. In other words, it can be considered that [AA]=[BB].

For alternating copolymers, the following designation can be represented:

AA (which in the context of the present invention is the diamine component “X”),

BB are the dicarboxylic acids, BB1 is Y and BB2 is Z.

The molar sum of all monomers=1.
Thus for the class of polyamides of the present invention, a perfectly alternating AA-BB1-AA-BB2 copolyamide (also designated as X-Y-X-Z in the context of the present invention), the degree of randomness R can be calculated from the probability distribution according to Devaux et al., J. Pol. Sci.: Pol. Phys. 20, 1875-1880 (1982) with formula (I):

$$R = \frac{f ( {BB}^{1} {AABB}^{2} )}{{F}_{BB} 1} + \frac{f ( {BB}^{2} {AABB}^{1} )}{{F}_{BB} 2} \qquad ( I )$$

Where F_{BB}1 is the molar fraction of monomer BB¹ (also designated in the present invention as Y) of all BB monomers, which is calculated by formula (II):

$${F}_{BB} 1 = \frac{[ {BB}^{1} ]}{[ {BB}^{1} ] + [ {BB}^{2} ]} \qquad ( II )$$

F_{BB}2 is the molar fraction of monomer BB² (also designated in the present invention as Z) of all BB monomer units in the copolymer:

$${F}_{BB} 2 = \frac{[ {BB}^{2} ]}{[ {BB}^{1} ] + [ {BB}^{2} ]} \qquad ( III )$$

In other words, in the context of the present invention, F_{BB}¹ is the molar fraction of Y (F_{Y}) in the sum of Y and Z dicarboxylic acids; F_{BB}² is the molar fraction of Z (F_{z}) in the sum of Y and Z dicarboxylic acids (the sum is also designated in the present invention as [Y]+[Z]).
The term “f(BB¹AABB²)” is the distribution function (in the present invention designated as f(YXZ)) of the tryad selection (fraction of units showing said triad formation as recited in Devaux et al., which is determined via ¹³C-NMR.
Mathematically, for perfectly alternating copolyamides R is always 2 (F_{BB}1=0.5 and F_{BB}2=0.5, f(BB¹-AA-BB²)=0.5 and f(BB²-AA-BB¹)=0.5 and thus R=2. In a statistical copolyamide R=1 and in a block copolyamide R=0.
Accordingly, in the context of the present invention, the PA XY/XZ copolyamide is considered as having (perfectly) alternating repeat units of XY and XZ, when R is at least 1.5, advantageously at least 1.6, more advantageously at least 1.7, most advantageously at least 1.8, still most advantageously at least 1.9.

Advantageously, either PA XY is a semi-crystalline semi-aromatic polyamide, or PA XY is an (cyclic or linear) aliphatic polyamide obtained from a C2 to C36 dicarboxylic acid, preferably from a C6 to C36 dicarboxylic acid, more preferably a C10 to C36 dicarboxylic acid and/or from a C2 to C36 diamine, preferably from a C4 to C36, more preferably from a C12 to C36 diamine or from a C4 to C10 diamine. PA XY can also be an aliphatic polyamide obtained from C2 to C36 dicarboxylic acid and/or a C2 to C36 diamine, such as a polyamide is advantageously selected from the group consisting of PA 410, PA412, PA418, PA 436, PA 610, PA 612, PA618, PA 636, PA 812, PA818, PA 836, PA 1012, PA1018, PA1036, PA1212, PA1218, PA1236, PA 1812, PA1818, PA 1836. In an embodiment of the present invention, Y is an aromatic dicarboxylic acid or a cyclic aliphatic dicarboxylic acid, preferably a terephthalic acid, 4,4′-biphenyldicarboxylic acid (BB) and 2,6-naphthalenedicarboxylic acid (N), 1,4-trans-cyclohexanedicarboxylic acid (CHDA), or derivatives thereof. In a preferred embodiment, PA XY is a semi-crystalline semi-aromatic polyamide, Y can advantageously be chosen from the group consisting of a phthalic acid, such as terephthalic acid, or isophthalic acid, or another aromatic dicarboxylic acid such as 4,4′-biphenyldicarboxylic acid or 2,6-naphthalenedicarboxylic acid. When the PA XY unit is a semi-crystalline semi-aromatic polyamide unit, the salts from which the alternating copolymers are produced have higher melting points, providing the possibility of solid state polymerization at an acceptable reaction speed and/or lower sticking and higher alternating character. More preferred embodiments are advantageously PA4T, PA41, PA4N, PA4BB, PA4CHDA, PA5T, PA5N, PA5BB, PA5CHDA, PA6T, PA6N, PA6BB, PA6CHDA, PA61, PA7T, PA8T, PA81, PA9T, PA91, PA10T, PA10N, PA10BB, PA10CHDA, PA10I, PA11T, PA11I, PA12T, PA121, PA14T, PA141, PA16T, PA161, PA18T, PA181, PA24T, PA241, PA36T, PA361.

Advantageously, Z is an aliphatic dicarboxylic acid comprising at least 6 carbon atoms in total, such as adipic acid, pimelic acid, suberic acid, azeleic acid, sebacic acid undecanedioic acid, dodecanedioic acid, tetradecanedioic acid, hexadecanedioic acid, octadecanedioic acid and dimerized fatty acid like for example Pripol 1009. The aliphatic dicarboxylic acid may present the advantage of a higher reactivity compared to an aromatic dicarboxylic acid, providing a higher reaction speed and/or lower sticking and higher alternation character. The dicarboxylic acid can also have an unsaturation like for example fumaric acid. Z can advantageously have 6 carbon atoms or more, 7 carbon atoms or more, 8 carbon atoms or more, 9 carbon atoms or more, 10 carbon atoms or more, 11 carbon atoms or more, 12 carbon atoms or more, 14 carbon atoms or more, 16 carbon atoms or more, 18 carbon atoms or more, 36 carbon atoms or more. PA XZ is an aliphatic polyamide obtained from Z being a linear C6 to C36 dicarboxylic acid or a dimerized fatty acid or a mixture of these dicarboxylic acids and X being a linear C2 to C36 diamine or a dimerized diamine or a mixture of these diamines as defined above. The polyamide PAXZ is advantageously selected from the group consisting of PA2,6, PA2,8, PA2,9, PA2,10, PA2,12, PA2,14, PA2,16, PA2,18, PA2,T, PA4,19, PA2,20, PA2,36, PA 4,6, PA4,8, PA4,9, PA4,10, 4,12, PA4,14, PA4,16, PA4,18, PA4,19, PA 4,36, PA4,T, PA 6,12, PA6,18, PA 6,36, PA6,T, PA 8,12, PA8,18, PA 8,36, PA9,T, PA 10,12, PA10,18, PA10,36, PA10,T, PA12,12, PA12,18, PA12,36, PA12,T, PA 18,12, PA18,18, PA 18,36, PA18,T. In the context of the present invention, a dimerized fatty acid is a fatty acid based dicarboxylic acid of between 24 and 44 carbon atoms. Such dicarboxylic acids may be obtained by the dimerization of a monomeric unsaturated fatty acid and is generally referred to as dimerized fatty acid. After the dimerization reaction the so obtained oligomer mixture is further processed, for example by distillation, to yield a mixture having a high content of the dimerized fatty acid. It is also possible to produce a derivative of the dimerized fatty acid by replacing one or two of the acid groups by an amine group by well-known reactions.

The dimerized fatty acid and/or diamine derived therefrom more preferably contains from 32 up to 44 carbon atoms. In said range the polyamide obtained has a lower level of moisture absorption and a higher melt temperature. Most preferably the dimerized fatty acid and/or diamine derived therefrom contains 36 carbon atoms. The amount of C-atoms normally is an average value, since the dimerzsed fatty acids and/or diamines derived therefrom normally are commercially available as a mixture. Further details relating to the structure and the properties of the dimerized fatty acid may be found in the corresponding leaflet “Pripol C36-Dimer acid” of the company Croda, (former UNICHEMA, Emmerich, Germany) or in the brochure of the Company COGNIS (Dusseldorf, Germany) “Empol Dimer and Poly-basic Acids”; Technical Bulletin 114C (1997). The diamines are typically produced from the dicarboxylic acids and are for example produced and sold by Croda under the commercial name Priamine™. The double bonds in the dimerized fatty acid and/or diamine derived therefrom, may be saturated by catalytic hydrogenation. It is preferred that the dimerized fatty acid and/or diamine derived therefrom is saturated.

Advantageously, X can be a diamine selected from the group consisting of C2 to C18 diamines. A higher degree of randomness R can be obtained when X is a C2 to C12 diamine (such as a C2 diamine, a C3 diamine, a C4 diamine, a C5 diamine, a C6 diamine, a C7 diamine, a C8 diamine, a C9 diamine, a C10 diamine, a C11 diamine, a C12 diamine) or a C18 diamine. When referring to a C# diamine, wherein # is the amount of carbon atoms in the diamine, it is to be understood in the context of the present invention that the diamine comprises # carbon atoms. For example, C2 diamine is an ethyldiamine, C4 diamine is a butyl-diamine. Preferably, the X diamine is a α,ω-linear aliphatic diamine. Advantageously, X can be a linear aliphatic diamine comprising an even number of carbon atoms, such as a linear aliphatic C2 diamine, a linear aliphatic C4 diamine, a linear aliphatic C6 diamine, a linear aliphatic C8 diamine, a linear aliphatic C10 diamine, a linear aliphatic C12 diamine, a linear aliphatic C14 diamine, a linear aliphatic C16 diamine, a linear aliphatic C18 diamine. More advantageously, X can be selected from the group consisting of 1,4-diaminobutane, 1,5 diaminopentane, 1,6-diaminohexane, 1,10-decanediamine, 1, 12-diaminododecane and 1,18-diaminooctadecane.

Advantageously, in the context of the present invention, a higher R has been obtained when Y is an aromatic dicarboxylic acid as referred to above, and Z is a C10 to C36 dicarboxylic acid, preferably C12, C18 or C36 dicarboxylic acid.

In a particularly preferred embodiment according to the present invention, the PA XY/XZ copolyamide having alternating units of:
a first polyamide XY wherein Y is chosen from the group consisting of a phthalic acid, such as terephthalic acid, or isophthalic acid, and another aromatic dicarboxylic acid such as 4,4′-biphenyldicarboxylic acid or 2,6-naphthalenedicarboxylic acid; or wherein Y is a cyclic aliphatic dicarboxylic acid and
a second polyamide XZ wherein Z is chosen from the group consisting of Z is an aliphatic dicarboxylic acid comprising at least 6 carbon atoms in total, such as adipic acid, pimelic acid, suberic acid, azeleic acid, sebacic acid undecanedioic acid, dodecanedioic acid, tetradecanedioic acid, hexadecanedioic acid, octadecanedioic acid and dimerized fatty acid like for example Pripol 1009.
   In this particularly preferred embodiment, X can be any diamine, preferably a linear C2 to C12 diamine as describe herebelow.

It has been shown that when the Y is an aromatic or a cycloaliphatic dicarboxylic acid and the Z is an aliphatic dicarboxylic acid having at least 6 carbon atoms in total, advantageously at least 8 carbon atoms in total the degree of randomness R is higher than if Z is an aromatic or a cycloaliphatic dicarboxylic acid and Y is an aliphatic dicarboxylic acid having at least 6 carbon atoms in total and further the process for the preparation of these copolyamides with alternating repeat units are more difficult to prepare because of the low melting temperature of the salt and the high reaction temperature needed. Examples can be PA 4T/418 prepared from diamine 4-18-4 with terephthalic acid as diacid, or PA 6T/618 prepared from diamine 6-18-6 with terephthalic acid.

In the process according to the present invention, amounts of components such as monofunctional monomers and/or trifunctional (triamines or tricarboxylic acids) and/or aminoacids can be added in one, two or all steps a), b) and c) of the process according to the present invention. For instance, up to 5 wt. % of such components can be added, wt % being relative to the total weight of the diamine X and dicarboxylic acids Y and Z in the process according to the present invention.

Surprisingly, when PA XY/XZ alternating copolyamide having alternating units are manufactured according to the process of the present invention, copolyamides with higher melting points and higher crystallinities can be obtained than with conventional processes (i.e. compared to processes which may attempt to form copolyamides with perfectly alternating units of each polymer block and which do not comprising steps a) to c) to produce a copolyamide with equal monomer composition).

The copolyamides of the present invention can be processed in solution or in the melt, or in solution, or in the solid state. It is preferred to process the materials in solution or in the solid state since it limits the decrease in melting point upon processing by avoiding high processing temperatures. Accordingly, a polyamide composition comprising the PA XY/XZ alternating copolyamide according to the present invention can be processed with a further polyamide by a process selected from the group consisting of melt processing, solution processing and solid state processing. According to the present invention, another aspect relates to polyamide compositions comprising the PA XY/XZ alternating copolyamide according to the present invention and at least one further component, such as a further polyamide (such as any polyamide, or copolyamide), or an additive. In the context of the present invention, the polyamide composition comprising the PA XY/XZ copolyamide obtainable by the process according the present invention or as defined herewith can be manufactured by adding at least one at least one further component. The polyamide composition manufacturing process may result in lowering of the R value of the initial PA XY/XZ alternating copolyamide (such as down to R=1.5). When processing is done in the melt, the conditions advantageously prevent the material from substantial transamidation to a random copolymer, which is favorable for PA XY/XZ polyamides with low melting points and low content of reactive end groups [NH2] and [CO2H] (which can be realized by increasing the molar mass or by introducting monofunctional monomers). The melting point of the copolyamide for enabling is advantageously below 300° C., more advantageously below 290° C. most advantageously below 280° C. and preferably the product of [NH2] and [CO2H] end group content can advantageously be below 10000 meq²/kg², more advantageously below be below 5000 meq²/kg² which can be done by providing a higher molar mass material or by adding monofunctional monomers for example in process step 3 (preferably monoamines) or short chain oligomers that are end capped with mono functional monomers. The end group content can be determined by titration or by NMR technique and is typically given in meq./kg, so mmoles of end group per kg polymer. For avoiding randomization in a melt processing step, the residence time in the melt at higher temperatures is advantageously kept as short as possible, preferably below 10 minutes, more preferably below 5 minutes and the temperature is advantageously kept as low as possible, preferably below 370° C., more preferably below 330° C., most preferably below 300° C.

The process according to the present invention further provides the advantage of reducing, or preventing moisture uptake. In other words, according to the process of the present invention, the resulting copolyamides with alternating repeat units have a lower moisture uptake compared to statistic copolyamides of the same monomer composition.

F_{BB}1, F_{BB}2, f(BB¹-AA-BB²) and f(BB²-AA-BB¹) can be quantified by the integral of the middle CH2 groups (for example, with X (=AA) has 4 or 6 carbon atoms, and Y(=BB1) terephthalic acid) of the diamide signals of the PA XY/XZ obtained by ¹³C-NMR spectroscopy according to experts known in the field of NMR and, the numbers obtained, R can be calculated.

According to another aspect of the present invention, the alternating PA XY/XZ copolyamide obtainable by the process as defined herein, has a R of at least 1.5 as determined by the integral ratio of the middle two C atoms in the diamine ¹³C-NMR as calculated from the probability distribution according to Devaux et al., J. Pol. Sci.: Pol. Phys. 20, 1875-1880 (1982) (Devaux et al). R is advantageously at least 1.5: advantageously in the range from 1.7 to 2, more advantageously in the range from 1.9 to 2, most advantageously R is 2. The PA XY/XZ copolyamide obtainable by the process as defined herein advantageously has a melting temperature similar to the average melting temperature of the two homopolymers PA XY and PA XZ based on the monomers in the units present in the copolyamide wherein the melting temperatures values determined by DSC at a heating rate of 10° C./min according to standard ISO 11357-3 (2009).

A randomness parameter can be determined for the alternating copolyamide according to the present invention, as the difference of the melting point to that of the same monomer composition (monomers X, Y and Z), when produced by flash or melt polymerization. The alternating copolyamide (also designated as PA XY/XZ copolyamide having alternating XY and YZ units) according to the invention advantageously have a melting point of at least 5° C., advantageously at least 10° C., more advantageously at least 15° C. above the melting point of the statistical copolymer and melt enthalpy of at least 10 J/g higher, except for Y=terephthalic acid and Z=adipic acid where Tm is at least 5° C. and melt enthalpy is at least 5 J/g higher than melt enthalpy value of the statistical copolymer (values determined by DSC at a heating rate of 10° C./min according to standard ISO 11357-3 (2009)). Accordingly, the PA XY/XZ copolyamide having alternating XY and YZ units obtainable by the process according to the present invention may advantageously have a melting temperature of at least 5° C., advantageously at least 10° C., more advantageously at least 15° C. above the melting point of the statistical copolymer. When Y=terephthalic acid and Z=adipic acid, Tm is at least 5° C. The PA XY/XZ copolyamide having alternating XY and YZ units obtainable by the process according to the present invention may advantageously have a melt enthalpy of at least 10 J/g above the melt enthalpy value of the statistical copolymer (values determined by DSC at a heating rate of 10° C./min according to standard ISO 11357-3 (2009)), except when Y=terephthalic acid and Z=adipic acid, the melt enthalpy is at least 5 J/g above the melt enthalpy value of the statistical copolymer.

The alternating copolyamide according to the present invention advantageously have a melting point of from 1° C. to 30° C., advantageously from 1° C. to 25° C., more advantageously from 1° C. to 20° C., or from 15° C. to 20° C., below the linear average of melting temperature of the two homopolymers PA XY and PA XZ based on the monomers in the units present in the copolyamide. According to yet another aspect, the present invention relates to a melt processing polyamide composition comprising the alternating PA XY/XZ copolyamide obtainable by the process according to the present invention advantageously having a R of at least 1.5 are recited herein.

An additional polymer (such as polyimides (PI) polyethersulfones (PES), polyetherimides (PEI), polysulfones (PSU), polyarylates (PAR), amorphous polyamides, semi-crystalline polyamides, polyetheretherketones (PEEK), polyphenylesulfides (PPS), polyesters and blends thereof), preferably a further polyamide can be advantageously present in the polyamide composition according to the present invention. Said composition may be a blend of PA XY/XZ and the additional polyamide. The advantage of said blend of polyamides is that the presence of the alternating copolyamide (PA XY/XZ) according to the present invention has a lower moisture uptake and a higher stiffness at high temperatures compared to using an alternating copolyamide. Said blend may comprise additives. The additives can be such as fillers like glass fibres, mineral fibres or carbon fibres, plasticizers, pigments, thermoconductive additives (resulting in a thermoconductive composition comprising the copolyamide defined in the present invention), additives for improving the copolymer heat ageing resistance, such as additives in the form of particles chosen from elementary metals, metals salts, metal oxides and mixtures thereof, flame retardant additives.

According to the present invention, a wide range of articles comprising the PA XY/XZ copolyamide having alternating units according to the present invention can be produced. Articles manufactured with a polyamide composition comprising or consisting of the PA XY/XZ copolyamide having alternating units according to the present invention can be manufactured by melt processing, solution processing, or solid state processing. The PA XY/XZ copolyamide having alternating units or its salts according to the present invention can also be processed by powder coating or 3D printing technique. These techniques have the advantage that the residence time in the melt is low, avoiding or limiting transamidation. Industrial processing is therefore favored, since the polymer can be provided as particles. The PA XY/XZ copolyamide processed as described herewith can be advantageously processed together with additional/further components, such as other polymers (such as polyimides (PI) polyethersulfones (PES), polyetherimides (PEI), polysulfones (PSU), polyarylates (PAR), amorphous polyamides, semi-crystalline polyamides, polyetheretherketones (PEEK), polyphenylesulfides (PPS), polyesters and blends thereof), organic or inorganic pigments, or other additives used in powder coating resins or 3D printing techniques. The alternating copolyamides according to the present invention can be mixed with additives and melt processed by extrusion or injection moulding, or processed from solution for example solution casting, gel spinning and electrospinning. It can also be processed by solid state processing to form for example sheets, films, or stock shapes like rods or plates. In an embodiment of the present invention, the alternating copolyamide according to the present invention can be processed by solid state processing at a temperature of at most 50° C., preferably at most 20° C. below the melting point of the copolyamide, providing the advantage of avoiding or largely reducing solvents (used in solution processing) or avoiding the transamidation (in melt processing). In the process according to the present invention, the melting point of PA XY/XZ can be lowered by adding a plasticizer, such as volatile plasticizer (for example a diol or water) providing the advantage of rising the melting point again upon removing the plasticizer after solid state processing. In a preferred embodiment of the invention the PA XY/XZ alternating copolyamide chains can be oriented by solid state processing by applying a shear force while solid state processing. In the context according to the present invention, the salt, precursor of the alternating copolyamide XY/XZ is designated as “XYX, Z” wherein the comma “,” designates that the copolyamide has been prepared according to the process of the present invention via the salt formation step b)). The solid state processing step has the advantage that the flow in the melt is higher than homopolyamides. The solid state processing can be followed by direct solid state polycondensation of the shaped articles, which provides the advantage that articles of high crystallinity are obtained which have high stiffness and low moisture uptake. Solid state processing works particularly well for salts which show a second endotherm below the melting point where the mass loss occurs. In a variation of the solid state processing of the salts as described in the present invention, the processing may occur by applying a shear force while solid state processing for example to make sheets or films, providing the advantage that the salt structures are oriented in a particular direction and that after direct solid state polycondensation of the shaped article a polyamide article can be obtained with a high orientation of the polyamide chains, leading to articles with improved mechanical strength. The additives can be such as thermoconductive additives (resulting in a thermoconductive composition comprising the copolyamide defined in the present invention), additives for improving the copolymer heat ageing resistance, such as additives in the form of particles chosen from elementary metals, metals salts, metal oxides and mixtures thereof, flame retardant additives.

According to still another aspect, the present invention relates to a diamine having the formula XYX as defined and/or obtained by step a) of the process according to the present invention. Accordingly, the diamine having the formula XYX is herewith an intermediary product of the process for the manufacture of the copolyamide according to the present invention. According to one embodiment, the diamine XYX is made from a linear diamine X with at least 9 carbon atoms and terephthalic acid or a derivative thereof, for example dimethylterephthalate or polyethyleneterephthalate (PET) which can be designated as having bio-based content with a low carbon foot-print because of the low carbon footprint of terephthalic acid and the re-use of PET waste. Also it has the advantage that polyamides with lower melting points can be made which can be processed more easily in the melt.

According to still another aspect, the present invention relates to a salt having the formula (XYX)Z as defined in step b) of the process according to the present invention: the salt therefore comprises (or even consists of) a cation XYX and an anion Z. Accordingly, the salt having the formula (XYX)Z is herewith an intermediary product of the process for the manufacture of the copolyamide according to the present invention.

The diamine XYX can advantageously be made, or produced as follow. The XYX diamine can be made (in step a) of the process according to the present invention) by heating 1 mole of dicarboxylic acid or derivative thereof Y, in presence of at least 2 mole diamine X optionally with a solvent other than the diamine X used. In the process step according to the present invention wherein the diamine XYX is made, the temperature may be increased during this process step in order to achieve that X and Y react to XYX and a co-condensate. The co-condensate is water in case X is a diamine and Y is a dicarboxylic acid and for example is ethyleneglycol if X is a diamine and Y is polyethyleneglycol. Preferably the co-condensate is removed by distilling off during the preparation of XYX. The XYX diamine preferably precipitates from the reaction mixture from a solvent where the diamine and dicarboxylic acid or dicarboxylic acid derivate have some solubility, which provides the advantage that a higher selectivity towards the XYX diamine is achieved and that the XYX diamine can be collected by filtration. Optionally, the dicarboxylic acid or dicarboxylic acid derivate is added gradually to the reaction mixture during the reaction (semi-batch procedure). Said semi-batch procedure herewith described has the advantage that a higher selectivity towards the XYX diamine is achieved or that a lower diamine X can be used. The production of XYX diamines can be batch wise, semi-batch or continuous. The advantage of a continuous process is that the diamine excess does not have to be recycled or discarded. Purification is performed by filtration. Optionally the filtered product is recrystallized, which provides the advantage that a more pure product is obtained. Further, in order to make the salt (step b) of the process according to the present invention), the XYX diamine is reacted with the dicarboxylic acid or dicarboxylic acid derivate Z preferrably by predissolving the XYX diamine and the dicarboxylic acid or dicarboxylic acid derivate Z and combining both mixtures. The formed salt either precipitates during or directly after mixing or precipitates upon cooling. Optionally, a non solvent is added.

The present invention is illustrated by the following Examples.

### EXAMPLES

### Materials

The materials 1,4 diaminobutane (DAB), hexamethylenediamien (HMDA), bis(2-ethylhexyl)terephthalate, dimethylterephthalate (DMT), adipic acid, sebacic acid and potassiumtriflouroacetate were obtained from Acros. Hydrogenated Dimerized fatty acid was obtained as Pripol 1009 from Croda. 1,18-Octadecanedioic acid was obtained from Emerox (Emerox 118). DMSO, DMF, sodiumethoxide, acetone, hexafluoropropanol and ethanol (96%) were obtained from Acros. All chemicals were used as received.

Analysis Techniques

1H-NMR and 13C NMR spectra were taken with a Bruker 500 MHz spectrometer equipped with a 5 mm cryogenic cooled probe operating at 313K. For the 13C NMR, the samples were dissolved in H2SO4 using an extra inserted 5 mm tube containing CDCl3. The CHCl3 signal was taken a reference at 7.24 ppm.

The XTX diamine purity of examples 1a, 1b and 2 was determined from ¹H-NMR spectroscopy as described in literature (D. Husken, R. J. Gaymans, Polymer 44 (2003) 7043-7053, eq. 1):

e represents the integral of the peak corresponding to the CH2 group next to the amide bond.
f represents the integral of the peak corresponding to the CH2 group that is coupled to the NH2 end group.

For instance, the relevant NMR data of examples 1a, 1b and 2 are presented below.

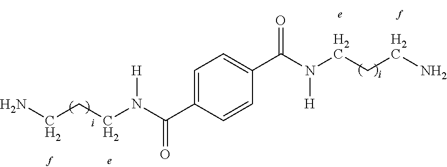

XTX diamine purity is defined as (2-e/f) 100%.

For the 13C NMR the sample was dissolved in hexafluoroisopropanol (HFIP). The HFIP resonance was taken as a reference at 77 ppm. When taking HFIP as a reference peak (68.07 ppm), 1.01 ppm has to be substracted from the shift values of table 2. For determining the randomness R.

Determined from the Integrals from ¹³C-NMR:

Randomness R in the copolyamide is determined from the following equation:

$$R = \frac{f ( {BB}^{1} {AABB}^{2} )}{{F}_{BB} 1} + \frac{f ( {BB}^{2} {AABB}^{1} )}{{F}_{BB} 2}$$

(equation as mentioned in introduction)

Where:

F_{BB}1 is the molar fraction of monomer BB¹ (or Y) of all BB monomers (Y+Z) in the copolymer.

$${F}_{BB} 1 = \frac{[ {BB}^{1} ]}{( [ {BB}^{1} ] + [ {BB}^{2} ]}$$

F_{BB}2 is the molar fraction of monomer BB² (or Z) of all BB monomer units in the copolymer.

$${F}_{BB} 2 = \frac{[ {BB}^{2} ]}{( [ {BB}^{1} ] + [ {BB}^{2} ]}$$

The relative molar contents of BB¹ and BB² a, [BB¹] and [BB²] are represented by the peak integrals of the carbon atom of the representative monomer units.

For the middle two C atoms in a diamine with an even numbered linear diamine X, a copolyamide PA XY/XZ can result in four peaks in the ¹³C-NMR spectrum.

f(BB¹AABB¹): is the integral of the two middle C atoms of the even numbered linear diamine X in the copolymer divided by the integral of all peaks corresponding to the middle C atoms of the even numbered linear diamine X.

f(BB¹AABB¹): is the integral of the two middle C atoms of the even numbered linear diamine X in the copolymer divided by the integral of all peaks corresponding to the middle C atoms of the even numbered linear diamine X.

f(BB¹AABB²) is the integral of the peak corresponding the C atom closest to the diacid or diacid derivate unit in the polyamide BB1 (or Y) of the two middle C atoms of the even numbered linear diamine X in the copolymer divided by the integral of all four peaks corresponding to the middle C atoms of the even numbered linear diamine X ((BB¹AABB¹)+(BB¹AABB²)+(BB²AABB¹)+(BB²AABB²)).

f(BB²AABB¹) is the integral of the peak corresponding the middle the C atom closest to the diacid or diacid derivative unit in the polyamide BB2 (or Z) of the two middle C atoms of the even number linear diamine X in the copolymer divided by the integral of all four peaks corresponding to the middle C atoms of the even numbered linear diamine X.

For odd numbered linear diamines X, there are three peaks, because the peak corresponding to (BB¹AABB²) also corresponds to (BB²AABB¹) and correspond to the middle C atom in the odd numbered linear diamines X. In this case f(BB¹AABB²)=f(BB²AABB¹) is 0.5 times the integral of the middle C atom of the odd numbered linear diamine X in the copolymer divided by the integral of all three peaks corresponding to the middle C atoms of the odd numbered linear diamine X ((BB¹AABB¹)+(BB¹AABB²)+(BB²AABB¹)+(BB²AABB²)).

Size Exclusion Chromatography measurement has been performed on Viscotek GPCMax VE2001 solvent/sample module system, equipped with TDA302 triple detector array. For chromatographic separation 3 PFG linear XL columns from PSS have been used. Detectors and columns were operated at 35° C. Prior Size Exclusion Chromatography polymer was dissolved in hexafluoroisopropanol/0.1% potassiumtriflouroacetate which was also used as an eluent in SEC at a flow rate of 0.8 ml/min. The molar mass has been determined with triple detection method, using the refractive index, differential viscosity and light scattering signals. For the calculation, a do/dc of 0.30 ml/g was used.

DSC is measured at a heating rate of 10° C./min according to standard ISO 11357-3 (2009). The peak half with of the melting point of the polymer is determined by measuring the with of the peak in ° C. at half the height of the peak height from the base line.

### Preparation of Diamine XYX

### Example 1a (EX 1a): Preparation of di-(4-aminobutyl)terephthalamide (4T4 diamine)

A flask was charged with 30 g bis(2-ethylhexyl)terephthalate, and 80 g 1,4-diaminobutane, and heated to 50° C. after which the sodium ethoxide (4 g) was added. After 17 hrs the reaction mixtures was cooled to room temperature after which 0.7 mL demineralized water was added to quench the catalyst. The resulting mixture was precipitated in acetone (1 L) filtered and the solid was washed with acetone. The crude material (14.6 g) was recrystallized from N,N-dimethylformamide (DMF, 600 mL), after which the solid was washed twice with DMF (2×50 mL) and twice with acetone (2×100 mL) and dried with a small stream of nitrogen in a 50 mbar vacuum at 50° C., resulting in a pure solid white 4T4. The bis(2-ethylhexyl)terephthalate conversion was 95% according to ¹H-NMR. The diamine had a DSC melting peak at 203° C., recorded at 20 K/min.

### Example 1b (EX 1b): Preparation of di-(4-aminobutyl)terephthalamide (4T4 diamine)

A mixture of dimethylterephthalate (DMT) (195 g, 1.0 mol) and DAB (880 g, 10 mol) was heated to 95° C. in a 3 liter stirred round bottomed flask with nitrogen inlet and a reflux condenser. Formed methanol was removed by distillation. After 8 h at 95° C. the thick suspension was filtered. Then the filter cake was stirred with 500 ml toluene at 85° C. The product was collected by filtration and three times washed with each time 60 ml hot toluene (85° C.). Finally the product was washed twice with each time 150 ml of ethanol (96%). and dried with a small stream of nitrogen in a 50 mbar vacuum at 50° C. The product was recrystallised in 3 portions by each time adding 5 liter n-butylacetate to 100 g of the product and refluxing at atmospheric pressure for 10 minutes and slow cooling to room temperature and filtering. The collected product was dried with a small stream of nitrogen in a 50 mbar vacuum at 50° C. total yield of 4T4 diamine was 228 g.

### Example 2 (EX 2): preparation of di-(6-aminohexyl)terephthalamide (6T6 diamine)

379 grams of 1,6-hexamethylenediamine and 78.1 grams of dimethylterephthalate were heated to 80° C. under a nitrogen atmosphere and stirred at 80° C. for 6 hours. The suspension was cooled to room temperature and 1 L of THF was added. The mixture was stirred for 30 minutes and filtrated. The product was recrystallized from 1,4-dioxane to yield the 6T6 diamine as a white crystalline powder (41% yield).

### Preparation of salt of XYX,Z

### Example 3 (EX3): Preparation of 4T4,6 Salt

20 ml of ethanol (96%) and 5 ml of DMSO was added to a 100 ml round bottom flask charged with 0.218 g 4T4 diamine of example 1 a. The mixture was stirred and heated under reflux until the solid had dissolved. 0.103 g Adipic acid was dissolved in 10 ml of ethanol (96%) at room temperature. Solutions were combined and after mixing allowed to cool to room temperature. Cream white precipitate filtered and washed with ethanol and dried with a small stream of nitrogen in a 50 mbar vacuum at 50° C.

### Example 4 (EX 4): Preparation of 4T4,10 Salt

20 ml of ethanol (96%) and 5 ml of DMSO was added to a 100 ml round bottom flask charged with 0.218 g 4T4 diamine of example 1a. The mixture was stirred and heated under reflux until the solid had dissolved. 0.144 g Sebacic acid was dissolved in 10 ml of ethanol (96%) at room temperature. Solutions were combined and after mixing allowed to cool to room temperature. Cream white precipitate filtered and washed with ethanol and dried with a small stream of nitrogen in a 50 mbar vacuum at 50° C.

### Example 5a (EX 5a): Preparation of 4T4,18 Salt

45 ml of ethanol (96%) and 15 ml of DMSO was added to a 100 ml round bottom flask charged with 0.202 g 4T4 diamine of example 1a. The mixture was heated under reflux until it dissolved. 0.226 g 1,18-octadecanedioic acid was dissolved under reflux at 95° C. in 10 ml of ethanol (96%). The dissolved dicarboxylic acid was added to the 4T4 diamine solution and the combined solution was mixed for 2 hours while refluxing and then cooled to room temperature. A cream white precipitate was filtered and washed with ethanol and dried with a small stream of nitrogen in a 50 mbar vacuum at 50° C.

### Example 5b (EX 5b): Preparation of 4T4,18 Salt

8 liter of ethanol (96%) and 8 liter of DMSO were mixed with 202 g 4T4 diamine of example 1 b. The mixture was heated in a mixed pressure vessel at 120° C. for 30 min hour. 256 g 1,18-octadecanedioic acid melted and added as a melt to the 4T4 diamine solution into reactor while mixing. The mix was cooled to room temperature and filtered, washed with ethanol and dried with a small stream of nitrogen in a 50 mbar vacuum at 50° C. Yield: 450 g of 4T4 18 salt.

### Example 6 (EX 6): Preparation of 4T4,36 Salt

50 ml of ethanol (96%) and 5 ml of DMSO was added to a 100 ml round bottom flask charged with 0.206 g 4T4 diamine of example 1a. The mixture was heated stirred under reflux for 1 hours. 0.42 g Pripol 1009 was dissolved in 4 ml of ethanol (96%) at room temperature. This solution was added to the 4T4 solution, which was then removed from the heat to cool, whilst stirring. White precipitate was filtered and collected and dried with a small stream of nitrogen in a 50 mbar vacuum at 50° C.

### Example 7 (EX 7): Preparation of 6T6,6 Salt

10 ml of ethanol (96%) and 8 ml of DMSO was added to a 100 ml round bottom flask charged with 0.237 g 6T6 diamine. The mixture was stirred and heated under reflux for 15 minutes. 0.102 g Adipic acid was dissolved in 10 ml of ethanol (96%) at room temperature. Solutions were combined and after mixing allowed to cool too room temperature. The white precipitate was filtered and washed with ethanol and dried at room temperature in the fume hood until constant weight by the stream of air passing. Yield was 0.265 g

### Example 8 (EX 8): Preparation of 6T6,10 Salt

10 ml of ethanol (96%) and 8 ml of DMSO was added to a 100 ml round bottom flask charged with 0.237 g 6T6 diamine. The mixture was stirred and heated under reflux for 15 minutes. 0.142 g sebacic acid was dissolved in 10 ml of ethanol (96%) at room temperature. Solutions were combined and after mixing allowed to cool too room temperature. The white precipitate was filtered and washed with ethanol and dried at room temperature in the fume hood until constant weight by the stream of air passing. Yield was 0.286 g

### Example 9 (EX 9): Preparation of 6T6,18 Salt

10 ml of ethanol (96%) and 8 ml of DMSO was added to a 100 ml round bottom flask charged with 0.237 g 6T6 diamine. The mixture was stirred and heated under reflux for 15 minutes. 0.220 g 1,18-octadecanedioic acid was dissolved in 10 ml of ethanol (96%) at 80° C. Solutions were combined and after mixing allowed to cool too room temperature. The white precipitate was filtered and washed with ethanol and dried at room temperature in the fume hood until constant weight by the stream of air passing. Yield was 0.370 g.

### Solid State Polymerization into the Copolymer with Alternating Units

### Example 10 (EX 10): Polymerization of 4T4,10 Salt into Alternating PA 4T/410 Copolymer

4T4,10 salt (8.442 mg) was weighed into an aluminum 0.04 ml crucible and closed with an aluminium lid perforated with a 0.05 mm hole. Sample was heated in a TGA instrument from 25° C. to 120° C. at a heating rate of 10 K/min and was held at 120° C. for 5 minutes. The sample was then heated to 190° C. at 10 K/min and held at 190° C. for 300 minutes. This was done under an atmosphere of N₂ at 50 ml/min. Over the whole process, 8.19% mass loss was recorded, 6.23% mass loss occurred whilst the sample was at 190° C.

### Example 11 a (EX 11a): Polymerization of 4T4,18 Salt into Alternating PA4T/418 Copolymer

4T4,18 salt (7.654 mg) of example 5a was weighed into an aluminum 0.04 ml crucible and closed with an aluminium lid perforated with a 0.05 mm hole. Sample was heated in a TGA machine from 25° C. to 120° C. at 10 K/min and was held at 120° C. for 5 minutes. Sample was then heated to 190° C. at 10 K/min and held at 190° C. for 300 minutes. This was done under an atmosphere of N₂ at 50 ml/min. Over the whole process, 6.62% mass loss was recorded, 5.81% mass loss occurred whilst sample was at 190° C.

### Example 11 b (EX 11 b): Polymerization of 4T4,18 Salt into Alternating PA4T/418 Copolymer

4T4,18 salt (350 g) of example 5b was weighed into a rotavap, equipped with a 2 liter flask and inertized by evacuation and filling with nitrogen. The flask was heated with an oil bath to 190° C. and kept at that temperature for 6 hours, allowing the water to be distilled off. Then content was cooled under a nitrogen stream, yielding 322 g of the PA 4T4,18 polyamide. With a melting point of 309°.

### Example 12 (EX 12): Polymerization of 4T4,36 Salt into Alternating PA4T4/36 Copolymer

4T4.36 salt (8.442 mg) was weighed into an aluminum 0.04 ml crucible and closed with an aluminium lid perforated with a 0.05 mm hole. Sample was heated in a TGA instrument from 25° C. to 120° C. at 10 K/min and was held at 120° C. for 5 minutes. Sample was then heated to 190° C. at 10 K/min and held at 190° C. for 300 minutes. This was done under an atmosphere of N₂ at 50 ml/min. Over the whole process, 4.15% mass loss was recorded, 4.01% mass loss occurred whilst sample was at 190° C.

### Example 13 (EX 13): Polymerization of PA 6T6,6 Salt into PA6T6,6 Copolymer

This was prepared as example 10, starting with 9.85 mg of 6T6,6 salt and reacting it for 600 minutes at 200° C. DSC melting point 313° C.

### Example 14 (EX 14): Polymerization of PA 6T6,10 Salt into Alternating PA6T6/10 Copolymer

This was prepared as example 10, starting with 9.95 mg of 6T6,10 salt and reacting it for 600 minutes. The observed mass loss at 190° C. was 6.1 wt. %. and DSC melting point 283° C.

### Example 15 (EX 15): Polymerization of PA 6T6,18 Salt into Alternating PA6T6/18 Copolymer

This was prepared as example 10, starting with 6.01 mg of 6T6,18 salt and reacting it for 600 minutes at 200° C. The observed mass loss was 5.6 wt. %. and DSC melting point 252° C.

### Comparative Examples

### Comparative Example 1 (CE 1): Statistical PA4T/418 (50/50 mole/mole)

PA4T/418 oligomer was prepared in a 2 liter pressure autoclave. DAB (280 g, 3.18 mole) was mixed with 490 g water and charged into the reactor, terephthalic acid (216 g, 1.3 mole) and 1,18 octadecanedioic acid (409 g, 1.3 mole) was added while stirring. The reactor was closed under inert conditions (N2). The content was heated to 200° C. in 30 min. At this temperature, 300 ml of water was removed by distilling off over 50 minutes, while keeping the pressure constant by heating the mixture. Then, the temperature was increased to 230° C. in 10 minutes and another 90 ml of water was distilled off over 20 minutes, while keeping the pressure constant by heating the mixture. Then, the temperature was increased to 250° C. in 10 minutes time and the mix was reacted for 20 minutes. The reactor content was flashed into an inertized vessel at atmospheric pressure, allowing the steam to leave the flashing vessel. The product was heated in a static bed reactor in a stream of N2 and steam in a 2 to 1 wt. ratio for 4 hours at 260° C. The product showed a low melt enthalpy of 70 J/g and an R value of 1.0 as calculated from the peak integrals of the ¹³C-NMR spectrum.

### Comparative Example (CE 2): Statistical PA6T/610 (50/50 mole/mole)

PA6T/610 was prepared in a 2 liter pressure autoclave. HMDA (217 g, 2.67 mole) and 0.5 g sodiumhypophosphitemonohydrate was dissolved into 338 g water and charged into the reactor. 217 g PTA (1.31 mole) and 267 g sebacic acid (1.31 mole) and 1.7 g benzoic acid (0.014 mole) were added while stirring. The reactor was closed and heated in 60 min to 250° C. The mix was kept at that temperature for 180 min, while keeping the pressure at 24 bar by allowing the water to evaporate. Then the reaction temperature was increased to 280° C. and the pressure was released over 60 min to atmospheric pressure by allowing the water to leave the reactor. The product melt then was released from the reactor and cooled in a water bath. The product was dried under vacuum oven at 50 mbar and 90° C. for 16 hrs. The product had a DSC melting point of 272° C. and a melt enthalpy of 35 J/g.

### Comparative Example 1 (CE 3): Statistical PA 4T/46

PA4T/46 oligomer was prepared according to Gaymans et al. (Journal of Polymer Science, vol. 27, no. 2, 1989, p. 423-430) in a 0.008 liter pressure autoclave. 46 salt ((salt of equimolar amounts of DAB and adipic acid, 0.96 g, 4.1 mmole) was mixed with 4T salt (salt of equimolar amounts of DAB and terepthalic acid, 1.04 g, 4.1 mmole) and charged into the reactor. On top of the powder mix, 0.058 g DAB and 0.1 g water was added. The reactor was closed under inert conditions (N2). The content was heated to 210° C. in 60 min and kept at that temperature for 40 min. The closed reactor was then cooled to room temperature in 5 min. The product was crushed and the powder was reacted in a static bed reactor in a stream of N2 and steam in a 2 to 1 wt. ratio for 4 hours at 260° C. The product showed an R value of 0.94 as calculated from the peak integrals of the ¹³C-NMR spectrum.

TABLE 1
XTX diamine 1H-NMR data and purities

| | | | | | | | XTX |
|---|---|---|---|---|---|---|---|
| | | Peak e | | Peak f | | | diamine |
| | | Shift* | intensity | Shift* | Intensity | elf | purity |
| | | Unit | | | | | |
| | i | ppm | — | ppm | — | — | % |
| EX 1a | 2 | 3.67 | 0.985 | 3.08 | 0.912 | 1.08 | 92 |
| EX 1b | 2 | 3.67 | 0.970 | 3.08 | 0.934 | 1.04 | 96 |
| EX 2 | 4 | 3.61 | 0.966 | 3.01 | 0.959 | 1.006 | 99.3 |

*Spectra taken from D₂SO₄ solution with CHCl₃ as reference peak at 7.24 ppm

TABLE 2
13C-NMR data for the determination of R

| | | | f(BB¹-AA- | f(BB²-AA- | f(BB¹-AA- | f(BB¹-AA- | |
|---|---|---|---|---|---|---|---|
| | | | BB²) | BB¹) | BB¹) | BB¹) | |
| | | | (integral) | (integral) | (integral) | (integral) | |
| | BB1 | BB2 | Shift | Shift | Shift | Shift | |
| | (F_{BB}1) | (F_{BB}2) | (ppm) | (ppm) | (ppm) | (ppm) | R |
| PA4T4, 10 | T | 10 | 25.86 | 25.80 | 25.92 | 25.73 | 2.0 |
| EX 10 | (0.50) | (0.50) | (0.50) | (0.50) | (0) | (0) | |
| PA4T4, 18 | T | 18 | 25.86 | 25.79 | 25.92 | 25.74 | 2.0 |
| EX 11a | (0.51) | (0.49) | (0.51) | (0.49) | (0) | (0) | |
| PA4T4, 18 | T | 18 | 25.86 | 25.79 | 25.92 | 25.74 | 2.0 |
| EX 11b | (0.50) | (0.50) | (0.50) | (0.50) | (0) | (0) | |
| PA4T4, 36 | T | 36 | 24.41 | 24.29 | — | — | 2.0 |
| EX 12 | (0.5) | (0.5) | (0.5) | (0.5) | (0) | (0) | |
| PA6T6, 10 | T | 10 | 25.84 | 25.78 | 25.88 | 25.75 | 1.8 |
| EX 14 | (0.5) | (0.5) | (0.45) | (0.45) | (0.05) | (0.05) | |
| PA 4T/418 | T | 18 | 25.87 | 25.79 | 25.92 | 25.74 | 1.0 |
| CE 1 | (0.51) | (0.49) | (0.25) | (0.25) | (0.26) | (0.24) | |
| PA 4T/46 | T | 6 | 25.81* | 25.81* | 25.92 | 25.71 | 0.94 |
| CE 3 | (0.48) | (0.52) | (0.23) | (0.23)* | (0.23) | (0.29) | |
| PA 418 | | | | | 25.92 | | — |
| | | | | | (1.00) | | |

*f(BB¹-AA-BB²) and f(BB²-AA-BB¹) occur as one peak of total integral 0.46.

TABLE 3
Tm, ΔHm, peak half widths and Mn data

| | | | | Peak | | | Mn |
|---|---|---|---|---|---|---|---|
| | | | | half | T½ | Mass | SEC |
| | | Tm | ΔHm | width | (min) | loss | (kg/ |
| Example | Copolymer | (° C.) | (J/g) | (° C.) | 190° C. | (wt. %) | mol) |
| EX 10 | PA 4T4, 10 | 318 | 144 | 6 | 187 | 7.5 | |
| EX 11a | PA 4T4, 18 | 309 | 142 | 5 | 80 | 5.61 | 4.8 |
| EX 11b | PA 4T4, 18 | 309 | | | | | |
| EX 12 | PA 4T4, 36 | 250 | 48 | 15 | 10 | 4.25 | Not |
| | | | | | | | sol |
| EX 13 | PA 6T6, 6 | 313 | 152 | | | 8.5 | |
| EX 14 | PA 6T6, 10 | 283 | 143 | | 140 | 6.1 | |
| EX 15 | PA 6T6, 18 | 252 | 116 | | | 5.5 | |
| CE 1 | PA 4T/418 | 260 | 70 | | | — | 10.9 |
| CE 2 | PA6T/610 | 272 | 35 | | >500 | | |
| | | | | | (melt) | | |

### Additional Experiment: Preparation of PA418

PA418 was prepared by heating the ceramic heating mantle of a 100 ml glass reactor (equipped with a magnetic stirring rod and a reflux condenser), containing a mix of 11.46 g (0.130 mol) DAB and 39.05 g (0.124 mol) 1,18-octadecanedioic acid under a nitrogen atmosphere subsequently at 145° C. for 105 minutes, 160° C. for 60 minutes, 180° C. for 225 minutes and 250° C. for 945 minutes. The product was cooled, milled to powder and dried in a vacuum of 50 mbar for 16 hrs.

1. Process for the manufacture of a PA XY/XZ copolyamide having alternating units XY and XZ of a first polyamide PA XY and a second polyamide PA XZ comprising:
a) reacting a diamine X and a dicarboxylic acid or a derivative thereof Y thereby making a XYX diamine;
b) reacting the XYX diamine with a dicarboxylic acid or a derivative thereof Z thereby making a salt XYX,Z thereof;
c) solid state polymerizing the salt XYX,Z obtained in b) at a temperature of at least 5° C. below the melting point of the salt XYX,Z obtained after step b) as measured by DSC at a heating rate of 10° C./min according to standard ISO 11357-3 (2009),
wherein
PA XY is a semi-crystalline semi-aromatic polyamide or an aliphatic polyamide obtained from a C2 to C36 dicarboxylic acid and a C2 to C36 diamine;
PA XZ is a semi-crystalline semi-aromatic polyamide or an aliphatic polyamide obtained from a C2 to C36 dicarboxylic acid and a C2 to C36 diamine, and Y and Z are different dicarboxylic acids or derivatives thereof.

2. Process according to claim 1, wherein Y is an aromatic dicarboxylic acid or a cyclic aliphatic dicarboxylic acid.

3. Process according to claim 1, wherein Y is terephthalic acid, 4,4′-biphenyldicarboxylic acid, 2,6-naphthalenedicarboxylic acid or 1,4-cyclohexanedicarboxylic acid, or a derivative thereof.

4. Process according to claim 1, wherein Z is an aliphatic dicarboxylic acid or derivative thereof comprising at least 6 carbon atoms.

5. Process according to claim 1, wherein X is a linear aliphatic diamine selected from the group consisting of C2 to C18 diamines.

6. Process according to claim 5, wherein X is a linear aliphatic diamine comprising an even number of carbon atoms.

7. Process according to claim 5, wherein X is selected from the group consisting of 1,4-diaminobutane, 1,6-diaminohexane, 1,10-diaminodecane, 1, 12-diaminododecane and 1,18-diaminooctadecane.

8. PA XY/XZ copolyamide having alternating XY and YZ units obtainable by the process as defined in claim 1, wherein the copolyamide has a degree of randomness R of at least 1.5 as determined by the integral ratio of the middle C atoms in the diamine ¹³C-NMR as calculated from the probability distribution according to Devaux et al., J. Pol. Sci.: Pol. Phys. 20, 1875-1880 (1982).

9. PA XY/XZ copolyamide having alternating XY and YZ units obtainable by the process as defined in claim 1, wherein the copolyamide has a melting temperature in the range of at least 5° C. above the melting point of the statistical copolymer.

10. Polyamide composition comprising:
the PA XY/XZ copolyamide having alternating units XY and XZ obtainable by the process according to claim 1; and
at least one further component.

11. Polyamide composition according to claim 10, wherein one of the at least one further component is a further polyamide and wherein the composition is a blend of PA XY/XZ copolyamide having alternating units XY and XZ and the further polyamide.

12. Polyamide composition according to claim 10, wherein the PA XY/XZ copolyamide is processed with a further polyamide by a process selected from the group consisting of melt processing, solution processing and solid state processing.

13. Articles comprising the PA XY/XZ copolyamide according to claim 1.
